(19) United States
(12) Patent Application Publication
(10) Pub. No.: US 2017/0004701 A1
(43) Pub. Date: Jan. 5, 2017

(54) Lovely life costume and designer jewelry for emergency alert devices II

(71) Applicant: Elizabeth DeLaney Smith, Gainesville, FL (US)

(72) Inventor: Elizabeth DeLaney Smith, Gainesville, FL (US)

(21) Appl. No.: 14/999,627

(22) Filed: Jun. 7, 2016

Related U.S. Application Data
(63) Continuation of application No. 14/098,129, filed on Jan. 17, 2014, now Pat. No. 9,412,249.

(51) Int. Cl. G08B 25/12

(52) U.S. Cl. CPC G08B 25/12

(57) ABSTRACT

An ornamental enclosure and an emergency alert device comprising of a removable housing with a through hole with a actuator button placed within the through hole that is adjacent to the activation button of the alert device. Retainer tabs hold the alert device in place. The ornamental enclosure is distinguished by attachment mechanisms that are a belt buckle configured to engage a belt or a fastener configured to engage a wristband or bracelet. There is a free floating activation push button placed within the ornamental housing which depresses an adjacent actuator button that is positioned to engage the activation button of the alert device. Another embodiment is an ornamental enclosure with a through hole housing common internal emergency alert circuitry, a generic energy source and an activation push button placed within the through hole. The push button is adjacent to an actuator that when pressed causes the actuator to engage a common micro circuit board switch activation mechanism of the generic internal emergency alert circuitry. A variety of durable materials, styles and attachments may be utilized.

### CROSS REFERENCE TO RELATED APPLICATIONS

U.S. patent application Ser. No. 14,098,129

### STATEMENT REGARDING FEDERALLY SPONSORED RESEARCH OR DEVELOPMENT

Not Applicable

### THE NAMES OF THE PARTIES TO A JOINT RESEARCH OR DEVELOPMENT

Not Applicable

### BACKGROUND OF THE INVENTION

1. Field of the Invention

The present invention relates to all types of designs of costume and designer jewelry to accommodate emergency alert devices. The jewelry is an ornamental housing adaptable to all common emergency alert devices'. The present invention includes jewelry that could be made with generic internal alert circuitry to connect with existing and future emergency alert services and/or costume or designer jewelry that accommodates existing and future alert devices via encasing, housing or otherwise attaching to emergency alert devices. The jewelry would be made from a variety of durable materials. The jewelry is not made of cloth and it is not clothing but an attractive jewelry accessory. The jewelry transforms an unattractive alert device into a stylish accessory that increases the security and safety of the wearer.

2. Descriptions of Related Art

Millions of people are aging into their retirement years. Many more live alone or are at risk. Their safety and health may be compromised when a great number of them refuse to habitually wear unattractive emergency alert devices. Prior art fails to provide the flexibility of design and durability that Lovely Life Jewelry II does while transforming an emergency alert device from utilitarian in appearance to appealing and fashionable health, safety and security aides.

U.S. patent application Ser. No. 14,098,129 allowed May 2, 2016 to Smith describes an ornamental enclosure and an emergency alert device comprising a removable housing with a decorative front surface, a back surface, a through hole and sidewalls having retainer tabs. An actuator button is placed within the through hole and is adjacent to the activation button of the alert device. The removable housing comprises an attachment mechanism that is a loop configured to engage a necklace or pin configured to engage clothing.

U.S. Pat. No. 0,261,289 issued Oct. 18, 2012 to Wyner describes a protective case for an electronic device. The protective case has two layers, and inner cushion insert that surrounds a portion of the electronic device and an outer elastomeric shell. The cushion insert includes raised impact portions that extend through the cover, and that are capable of absorbing shocks from impacts.

U.S. Pat. No. 4,078,660 issued Mar. 14, 1978 to Lerro is for a medical alert bracelet for caring an emergency supply of the patient's medication comprising a bracelet strap and a blister package containing medicament form. The blister package is held in a bracelet strap, a hole is formed in the bracelet strap beneath the blister package for push-through it ejection of the medicament from the bracelet, and a closure is provided for closing the strap onto the wrist of the patient. A weakened line is positioned across the strap and is easily ruptured to remove the strap from the patient's wrist, and a locator notch is provided at the weakened line so that it is easily located, even in the dark. The invention also includes a method of making the medical alert bracelet.

U.S. Pat. No. 7,946,459 issued May 24, 2011 to Cheitman is a simple-to-use adornment device, and method, employed by a user close-at-hand for personal safety enhancement. It contains a personal alarm or remote control device while maintaining a capability for immediate alarm/remote activation to summon assistance. It has a jewelry appearance or comprises a modular casing to which exchangeable decorative elements can be attached. Since it improves the aesthetic look of an associated alarm/remote, users are more likely to wear it habitually and experience enhanced personal safety and well-being as a result thereof. Inner and outer members with asymmetrical keyed guides are in sliding relation to one another to form the casing with one way assembly, and a chord/chain connected to the members maintains their association with one another even when dissembled. Openings in each member or a line to provide activation button access. Optional features include an interior resilient spacer, a cover, a clasp, and a sheet pockets associated with the outer member.

U.S. Pat. No. 8,651,346 issued Feb. 18, 2014 to Williams provides a band for information storage includes an outer mold for attaching the band to a user's wrist, an external housing within the outer mold that includes a hollow upper portion for receiving a first removable component, wherein the first removal component is engraved with information about the user and/or includes an alarm alert or emergency call button; and an internal housing rotatably attached to the external housing and fitted therein for receiving a second removable component, wherein the second removal component includes a portable memory device.

U.S. patent application Ser. No. 0,366,249 published Dec. 18, 2014 for West describes that an elasticized styled cover sleeve covers and transforms any of a variety of personal emergency help buttons into a clothing accessory. Interchangeable differently styled cover sleeves enable matching the style of the transformed clothing accessory to a style of clothing worn by a user. An emergency button pressing portion of the cover sleeve positioned over a personal help button flexes to allow pressing the help button through the cover sleeve. Distinguishable decorative elements on the emergency button pressing portion reveal the location of the emergency button pressing portion and the personal help button beneath, when press, will summon help.

U.S. Pat. No. 2006/0,025,182 issued Feb. 2, 2006 to Tushinsky is an article for personal, vehicular or household use provides a visual alert for the presence of a mobile communication signal from a nearby but not physically connected communication device. The article includes a signaling assembly for providing a visual signal when a mobile communication signal is detected within a defined distance an antenna connected to the signaling assembly and extending from it. The signaling assembly may include a circuit module with and LED providing a visual signal when an adjacent mobile communication device is transmitting a signal within the defined distance. The defined distance is selected so as to make the article responsive only to signals from a mobile device within the users personal space.

U.S. Pat. No. 4,692,749 issued Sep. 8, 1987 to Bussing, provides a wearable alarm which can be in the form of a religious cross, jewelry or decorative article or the like normally found on the user's person, which, through simple sliding action, but achieves completion of a contained electrical circuitry and the energization of an audible signaling device. Entry to the operative components may be achieved in any manner, depending on the article in which the alarm is presented and, additionally, the audible alarm varied to provide a warning at any pre-selected distance from the wearer.

U.S. Pat. No. 5,420,570 and U.S. Pat. No. 5,258,746), issued May 30, 1995 to Leitten, et al, describes a personal alarm which is compact, portable and fashionably design. In one embodiment, this personal alarm is structurally incorporate it into a wristwatch with the alarm components arranged thereon in a fanciful yet highly functional manner. This alarm may also be structurally incorporated into other conventional items such as a bracelet, pendant, necklace, keychain ornament, or any other conventional item which is often carried by the persons to be protected. In a further embodiment, the compact size is achieved without sacrificing intensity in the alarm signal by incorporating a specially wound autotransformer and efficient switching device so as to provide a tuned warbling signal upon a piezo-electric transducer. Additionally, the alarm maybe activated or deactivated by manually actuating an actuator, such as a switch or plurality of switches, in a particular sequence.

### BRIEF SUMMARY OF INVENTION

A current need that is not being addressed in prior art is durable jewelry type adornment for emergency alert devices. Lovely Life Jewelry II is not a clothing accessory, a wearable personal alarm or a container for keys and remote controls. It is not a medication delivery device. It is not a memory storage unit or a modular sliding casing box. It is not a protective elastomeric case for a electronic device. This present patent is differentiated by the invention concept's function as ornamental housing referred to as jewelry that adorns all types of monitored emergency alert devices to provide a more palatable personal safety accessory. This jewelry is socially acceptable and attractive and, therefore, will increase the usage of the much needed emergency alert devices.

A primary objective of this present invention is to address the needs of the many who are aging into their retirement years, live alone or are at risk. A large number of these people refuse to habitually wear monitored emergency alert devices because the devices are unattractive in appearance. This present invention strives to increase the usage of these effective health, safety and security aides.

This objective overcomes the limitations of prior art by providing durable jewelry accessories specifically designed to enhance the appearance of monitored emergency alert devices. According to this invention, for example, fashion accessories such as bracelets, wrist watches, belt buckles or similar adornments could be adapted as Lovely Life Jewelry II. These embodiments would not contain a wireless signal alerting device. Further, the alternative embodiments of these personal articles with various modifications and adaptations may be made within the scope of the spirit of the present invention. Back ground art has described an adornment device with inner and outer members with asymmetrical keyed guides sliding in relation to one another to form a protective case assembly over remote controlled device or personal alarm. This background art does not address the alert device avoidance problems by providing multiple attractive styles and design enclosure options with durable material construction as does this invention's Lovely Life Jewelry II concept.

Prior art describes an ornamental enclosure and an emergency alert device comprising a removable housing with a decorative front surface, a back surface, a through hole and sidewalls having retainer tabs. An actuator button is place within the through hole and is adjacent to the activation button on the alert device to engage the alert device. The present invention differs from this prior art in that the attachment mechanisms are fasteners with belt buckles, wristbands, bracelets or other attachments excluding a loop configured to engage a necklace or a pin configured to engage clothing. Another embodiment of this present invention differentiates by describing an ornamental enclosure with a common internal emergency alert circuitry, a free floating activation push button adjacent to an actuator button which engages the generic alert circuitry when the actuator makes contact with a common micro circuit board switch. These ornamental enclosures are differentiated from prior art as being designed as decorative costume or designer jewelry that encases and/or is designed as an emergency alert safety device. These attractive personal safety accessories could be designed with diverse durable materials in various styles and with different attachment mechanisms.

A background art describes a protective case for an electronic device. The protective cushioned case is capable of absorbing shocks from impacts. This is not an ornamental housing specifically designed to include an actuator button that engages an emergency alert device or circuitry that may be attached to the wearer with a variety of mechanisms.

Prior art describes a wearable band including assessable memory and wearer information and call pendant. This background art does not make claims of a decorative appearance. Other background art describes a medical alert bracelet that dispenses medication, jewelry that contains electrical circuitry for an audible alarm or another that provides a tuned warbling signal upon a piezo-electric transducer. This present invention relates specifically to fashionably designed jewelry accessories adapted to enhance or constructed to improve the appearance of monitored emergency alert devices.

The present invention is not made of clothing materials nor is it a clothing accessory, rather it is ornamental jewelry adapted to monitored emergency alert devices to enhance the health, safety and security of the wearers. Lovely Life Jewelry II would be compatible with all current and/or all future emergency alert devices. Lovely Life Jewelry II would be compatible with all current and/or all future emergency alert services.

### BRIEF DESCRIPTION OF SEVERAL VIEWS OF EXAMPLE DRAWINGS

FIG. 1A is the front elevation view of this example of this patent concept presenting a belt buckle configuration. The view shows a center free floating push button that allows the transfer of pressure by depressing onto the emergency alert device housed beneath. This example is rectangular in shape with an ornamental façade. Illustrated is a belt buckle fastener through which a belt could be threaded. The visible elements could be made of costume or designer materials in various styles.

FIG. 1B is the rear elevation example of the belt buckle configuration of the present invention. The drawing shows how the emergency alert device is inserted to the housing and held in place by retainer tabs on the sides and bottom of the housing. An emergency alert device is shown with the device's activation button to be positioned under the actuator button when the device is placed in the decorative housing. A fastener can be seen on the belt buckle to which a belt may be attached.

FIG. 1C is the side elevation view of the example of this invention presented in the belt buckle configuration. The ornamental housing with the free floating push button, actuator and belt buckle fastener may be seen from the side view. Side views of the belt hook, retainer tabs and common emergency alert device are visible. The alert device activation button can be seen on this example drawing.

FIG. 2A is the front elevation of the wristband configuration example of Lovely Life Jewelry II. The ornamental housing in this example is shown with a free floating activation push button. The front elevation of a common emergency alert device with an alert device activation button is shown that will be inserted in wristband type ornamental housing.

FIG. 2B is the rear elevation view of the example of the present invention depicted in the wristband configuration. The drawing shows how an emergency alert device is inserted into the housing and held in place by retainer tabs on the side and at the bottom of the housing. The rear of the activation button with actuator of the ornamental housing is apparent. A wristband that is threaded through an wristband fastener attachment slot in the housing is visible.

FIG. 2C is the side elevation view of the example of the invention presented in the wristband configuration. The wristband type ornamental enclosure activation button is positioned over the actuator button. Actuator button is located so as to engage the activation button of the emergency alert device. The side view of the arm band is visible.

FIG. 3A is the front elevation view of this example of this present invention. It is shown in a locket configuration but may be designed in a variety of shapes. This view displays a free floating activation button within an ornamental façade. A hinge, locket closure snap and a loop attachment are noted.

FIG. 3B is a front elevation view of the present invention in the locket configuration. The drawing shows the locket in an open position revealing generic internal emergency alert circuit components. A loop configured to engage a necklace or bracelet for attachment to the wearer, a hinge to allow the locket to be opened and closed and a clasp to close the locket are present in this example illustration. There is a generic power source, a common micro circuit board switch, an activation push button and an actuator button in this depiction. This elevation is an example and may be designed in a variety of shapes, styles and attachment mechanisms to transform the common emergency alert device into an attractive safety accessory.

FIG. 3C is the side elevation view of the present invention example. This side view of the locket configuration has a snap closure. A loop attachment mechanism can be seen at the top of this drawing. An activation push button in the ornamental housing is depicted in the side view.

### DETAILED DESCRIPTION OF THE INVENTION

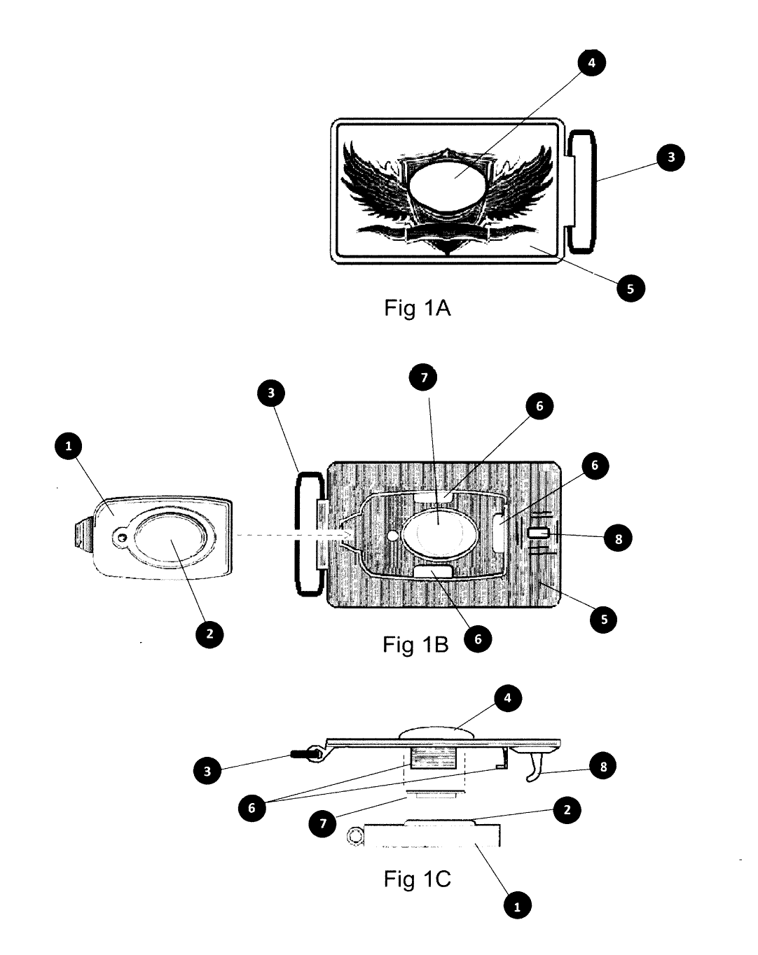

FIGS. 1A-3C shows examples of styles of costume or designer jewelry that disguises and ornaments a variety of emergency alert devices. These examples of Lovely Life Jewelry II are Ornamental Enclosures for Emergency Alert Devices. These attractive accessories can be made from costume or designer materials. The materials may vary. The styles may vary. The jewelry may be adorned with costume or designer jewels or other decorations. The jewelry is durable. The jewelry in these examples can be made from material such as base or precious metals, plastics, composites, enamels, ceramics, similar durable materials or other durable products. The decorations in these example designs can be made from glass, amethyst, rubies, diamonds, cubic zirconium or other products. Lovely Life Jewelry II will enhance the health, safety and security of targeted populations.

FIGS. 1A, 1B and 1C are a belt buckle housing and would be comprised of costume or designer durable materials. The housing 5 would disguise a common emergency alert device 1. The ornamental housing 5 is decorative and would enhance and disguise the alert device 1 making the device 1 more appealing in appearance. A free floating push button 4 would be sized appropriately to be depressed on the actuator button 7 which would engage the alert device activation button 2. The common emergency alert device 1 would be attached to the decorative housing by retainer tabs 6. The belt buckle housing ornamental facade 5 and belt buckle housing rear view 5 would have a belt buckle fastener 3 that would attach the belt buckle to the wearer via a belt threaded through the belt buckle fastener 3 slot. Belt hook 8 hooks into a eyelet of a conventional belt.

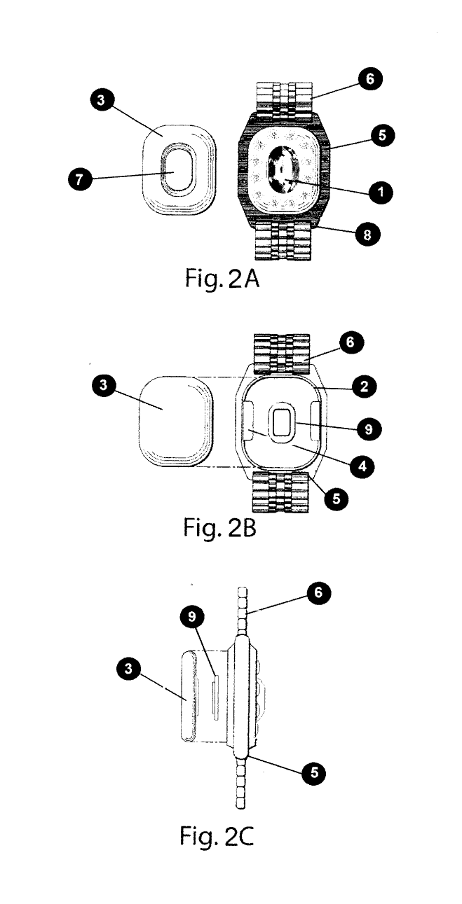

FIGS. 2A, 2B and 2C are a wristband configuration example of Lovely Life Jewelry II. FIGS. 2A, 2B and 2C are examples of decorative wristband housing and demonstrate how an enclosed common emergency alert device 3 can be transformed into a fashionable accessory capable of being used to summon assistance when the appropriately sized and positioned free floating push button 1 is depressed on the actuator button 9 to engage the common emergency alert device activation button 7. The wristband ornamental housing 5 has an attachment mechanism slot 8 to which wristband 6 is attached. The free floating push button 1 is compatible in size and positioned over the actuator button 9 and activation button 7 of the emergency alert device 3. Retainer tabs 4 hold the emergency alert device 3 firmly in place.

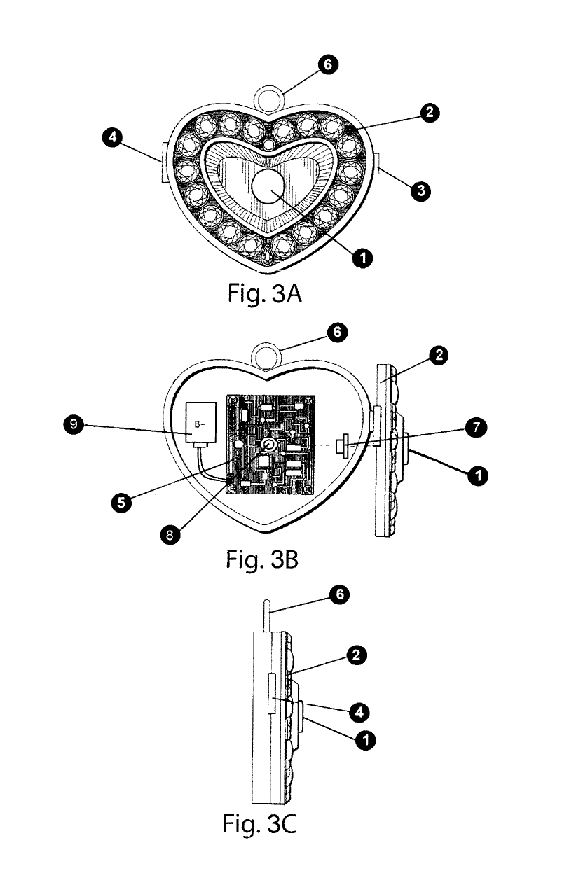

FIGS. 3A, 3B and 3C are examples Lovely Life Jewelry II designed with generic internal emergency alert circuitry components 5. These examples of the present invention depicts a ornamental façade housing 2 in a pendant locket configuration. A free floating activation push button 1 is positioned over the internal actuator button 7. Depressing the activation button 1 causes the adjacent actuator button 7 to make contact with the common micro circuit board switch 8 engaging the generic internal emergency alert circuitry components 5. A generic power source 9 is connected to the circuitry components 5. A locket hinge 3 allows the housing to open. A closure snap 4 will keep the housing closed. An attachment mechanism in the form of a loop 6 is configured to engage a necklace or bracelet

What is claimed is:

1. An ornamental enclosure and emergency alert device, comprising:
a removable housing having a front surface, a back surface, and a through hole, the front surface being ornamental, sidewalls surrounding the through hole extending from the back surface, the sidewalls have a retainer tabs extending towards the through hole and are substantially parallel to and spaced from the back surface;
a button actuator placed within the through hole; and
an alert device having an activation button on the front surface, and an opposite back surface, the alert device having sides complimentary in shape to the sidewalls to engage the sidewalls;
when the device is placed within the sidewalls, the activation button of the alert device is adjacent to the button actuator, and the back surface of the alert device engages retainer tabs;
wherein the removable housing comprises an attachment mechanism;
wherein the attachment mechanism is a fastener and a belt buckle configured to engage a belt.

2. An ornamental enclosure and emergency alert device, comprising;
a removable housing having a front surface, a back surface, and a through hole, the front surface being ornamental, sidewalls surrounding the through hole extending from the back surface, the sidewalls having retainer tabs extending towards the through hole and are substantially parallel to and spaced from the back surface;
a button actuator placed within the through hole; and an alert device having an activation button on the front surface, and an opposite back surface, the alert device having sides complimentary in shape to the sidewalls to engage the sidewalls;
when the alert device is placed within the sidewalls, the activation button of the alert device is adjacent to the button actuator, and the back surface of the alert device engages the retaining tabs;
wherein the removable housing comprises an attachment mechanism;
wherein the attachment mechanism is a fastener configured to engage a wristband or bracelet.

3. An ornamental enclosure and emergency alert device, comprising;
a removable housing having a front surface, a back surface, and a through hole, the front surface been ornamental, sidewalls surrounding the through hole extending from the back surface, the sidewalls having retainer tabs extending towards the through hole and are substantially parallel to and spaced from the back surface;
a button actuator placed within the through hole; and an alert device having an activation button on the front surface, and an opposite back surface, the alert device having sides complimentary in shape to the sidewalls to engage the sidewalls;
when the alert device is placed within the sidewalls, the activation button of the alert device is adjacent to the button actuator, and the back surface of the alert device engages the retaining tabs;
wherein the removable housing comprises an attachment mechanism;
wherein the ornamental enclosure and emergency alert device may have modifications, adaptations and alternate attachment mechanisms;
wherein the attachment mechanism is not a loop configured to engage a necklace;
wherein the attachment mechanism is not a pin configured to engage clothing.

4. An ornamental enclosure comprised of generic internal emergency alert circuitry with housing having a front surface, a back surface, a through hole, the front surface being ornamental, sidewalls, a activation push button placed within the through hole of the front surface, an actuator, a generic power source, an activation mechanism in the form of a common micro circuit board switch, the push button is adjacent to the actuator;
wherein when pushed the push button depresses
the actuator which makes contact with the common micro circuit board switch activation mechanism;
wherein the actuator button and the activation mechanism engage the generic emergency alert circuitry.

5. The ornamental enclosure and emergency alert circuitry of claim 4, wherein the housing comprises an attachment mechanism.

6. The ornamental enclosure and emergency alert circuitry of claim 4, wherein the attachment mechanism is a loop configured to engage a necklace or bracelet.

7. The ornamental enclosure and emergency alert circuitry of claim 4, wherein the attachment mechanism is a pin configured to engage clothing.

8. The ornamental enclosure and emergency alert circuitry of claim 4, wherein the attachment mechanism is a fastener and a belt buckle configured to engage a belt.

9. The ornamental housing and emergency alert circuitry of claim 4, wherein the attachment mechanism is a fastener configured to engage a wristband or bracelet.

10. The ornamental housing and emergency alert circuitry of claim 4, may have modifications, adaptations and alternative attachment mechanisms.
